(19) United States
(12) Patent Application Publication
(10) Pub. No.: US 2006/0285009 A1
(43) Pub. Date: Dec. 21, 2006

(54) Illuminating assembly for image-taking device

(76) Inventor: Jin-Sheng Lai, Hsi Chih City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/155,680

(22) Filed: Jun. 20, 2005

(51) Int. Cl. H04N 5/225

(52) U.S. Cl. 348/374

(57) ABSTRACT

An illuminating assembly includes a top case and a lower case which is connected to the top case. A board is connected to an inside of the top case and has a first hole for photographic sensing member engaged therewith, and a second hole for a Liquid Crystal Device engaged therewith. The lower case has a rough inner surface for diffusing the light and an inclined surface with rough surface which is located beneath the second hole.

### FIELD OF THE INVENTION

The present invention relates to an illuminating assembly for providing proper and sufficient light to photographic sensing member of an image-taking device.

### BACKGROUND OF THE INVENTION

A conventional image-taking device using photographic sensing member, such as computer-control letter cutting machine generally includes an illuminating assembly for providing sufficient light to the object so as to obtain satisfied image. In order to have desired brightness, some sophisticate illuminating assemblies are used which are complicated and difficult to install. Nevertheless, the expensive illuminating assembly cannot provide illumination as desired.

The present invention intends to provide an illuminating assembly which is less expensive and provides proper and sufficient light to photographic sensing member under the image-taking device.

### SUMMARY OF THE INVENTION

The primary purpose of the present invention is to provide proper and sufficient light to a photographic sensing member of an image-taking device.

To achieve the above purpose, the illuminating assembly comprises a top case and a lower case connected to the top case. A board is connected to an inside of the top case and has a first hole and a second hole. A photographic sensing member and a Liquid Crystal Device are respectively engaged therewith the first and second holes. The lower case has a rough inner surface which includes an inclined surface which is located beneath the second hole. Thus the light from the Liquid Crystal Device via the rough surface of the inclined surface in the lower case can be even diffused to obtain a satisfied illumination.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the illuminating assembly of the present invention;

FIG. 2 is a top view to show the top case of the present invention;

FIG. 3 is a perspective view to show the illuminating assembly of the present invention;

FIG. 4 is a cross section to show the connection of the top case and the lower case of the present invention, and FIG. 5 shows light diffused by the rough surface of the inclined surface of the lower case of the present invention.

### DETAILED DESCRIPTION OF THE PREFERRED EMBODIMENT

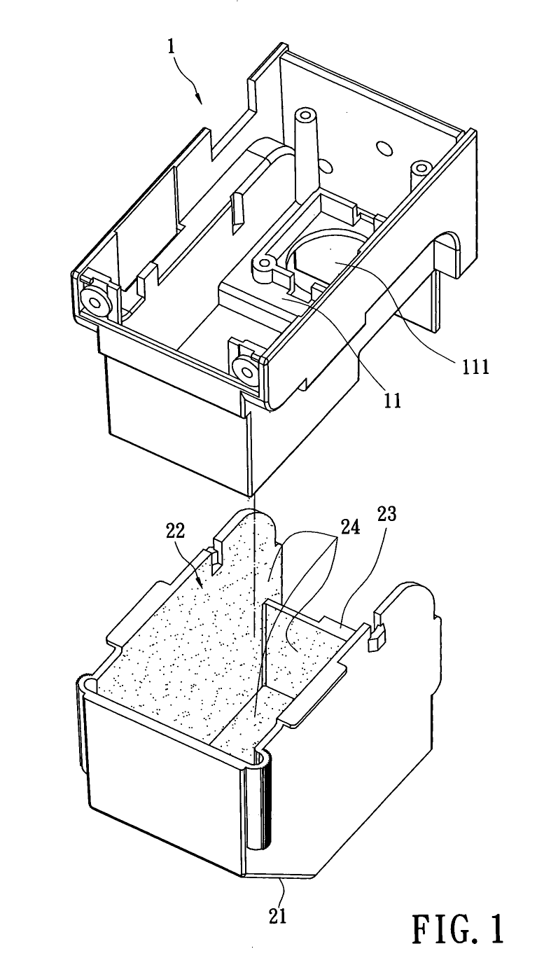

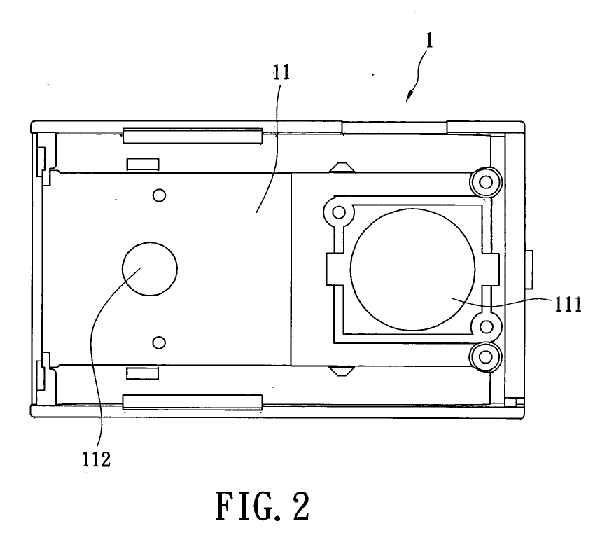

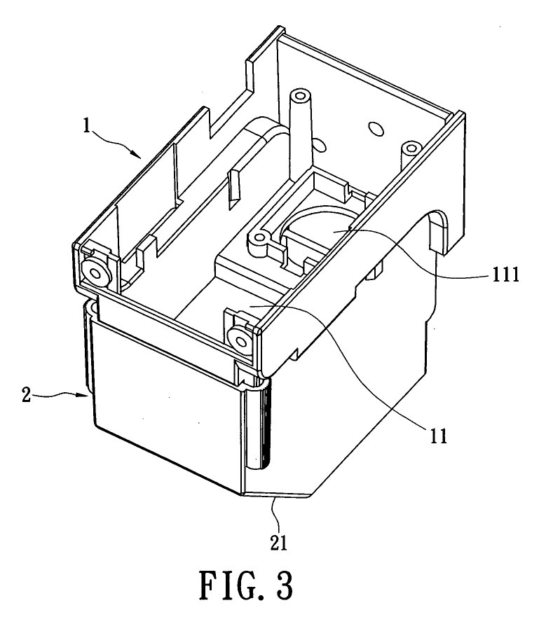

Referring to FIGS. 1 to 5, the illuminating assembly of the present invention comprises a top case 1 and a lower case 2.

The top case 1 includes a board 11 connected to an inside thereof and the board 11 has a first hole 111 and a second hole 112. The first hole 111 and the second hole 112 are located on right end and left end of the board 11. A photographic sensing member 3 and a Liquid Crystal Device 4 are respectively engaged with the first and second holes 111, 112. The first case 1 has a first connection wall 12.

A lower case 2 includes a space 22 defined therein and a second connection wall 23. The top case 1 is engaged within the space 22 of the lower case 2 when the first and second connection walls 12 and 23 are engaged with each other. The lower case 2 has a rough inner surface 24 which includes an inclined surface 21 which is located beneath the second hole 112.

The photographic sensing member 3 can be a Charge Coupled Device (CCD), a Complementary Metal Oxide Semiconductor (CMOS), CCD/CMOS Hybrid, or a Charge Injection Device (CID).

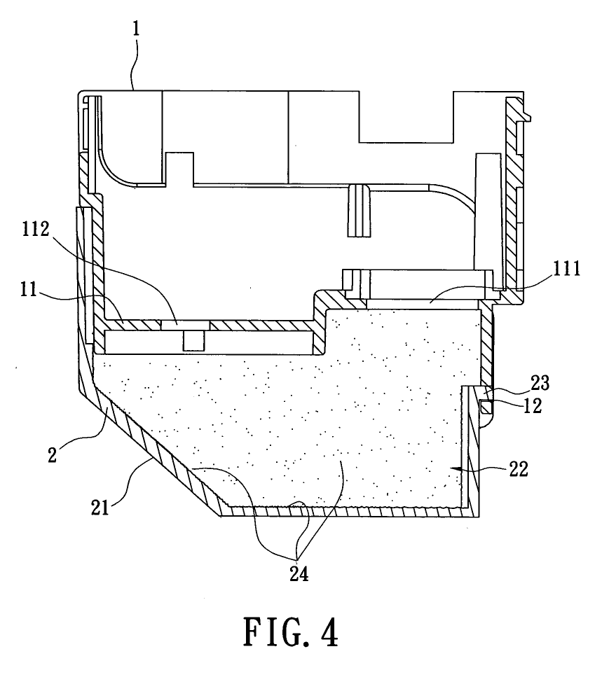

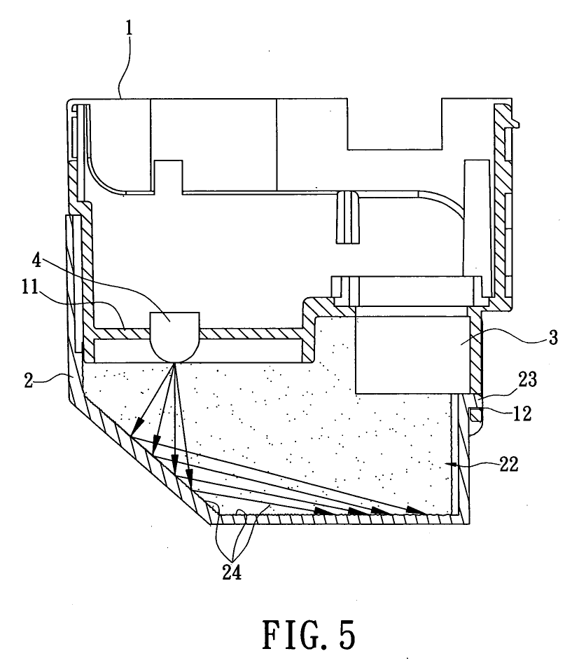

As shown in FIGS. 4 and 5, the light coming form the Liquid Crystal Device 4 is reflected by the rough surface of the inclined surface 21 of the lower case 2 and diffuses to provide the area beneath the first hole 111 where the photographic sensing member 3 is located, with even illumination.

The illuminating assembly of the present invention thus had the following advantages:

1. The illuminating assembly includes a simple structure so that it can be assembled within a short period of time, only one Liquid Crystal Device is required so that the cost is relatively low and affordable.

2. The rough surface of the inclined surface in the lower case diffuses the light from the Liquid Crystal Device so that a satisfied illumination is obtained under the CCD lens.

While we have shown and described the embodiment in accordance with the present invention, it should be clear to those skilled in the art that further embodiments may be made without departing from the scope of the present invention.

What is claimed is:

1. An illuminating assembly for installing in an automatic positioning system machine, comprising:
a top case and a lower case which is connected to the top case, a board connected to an inside of the top case and having a first hole and a second hole, a photographic sensing member and a Liquid Crystal Device respectively engaged with the first and second holes, the lower case having an inclined surface which is located beneath the second hole and the inclined surface having a rough surface.

2. The assembly as claimed in claim 1, wherein the photographic sensing member is a Charge Coupled Device (CCD), a Complementary Metal Oxide Semiconductor (CMOS), CCD/CMOS Hybrid, or a Charge Injection Device (CID).

3. The assembly as claimed in claim 1, wherein the first hole and the second hole are located on right end and left end of the board.

4. The assembly as claimed in claim 1, wherein the top case has a first connection wall and the lower case includes a space defined therein and a second connection wall, the top case is engaged within the space of the lower case when the first and second connection walls are engaged with each other.
